(19) United States
(12) Patent Application Publication
(10) Pub. No.: US 2009/0222699 A1
(43) Pub. Date: Sep. 3, 2009

(54) Method for Displaying Quality of a Digital Communications Link for Field Devices of Automation Technology

(75) Inventors: Chris Abbott, Indianapolis, IN (US); Frank Van Bekkum, Norcross, GA (US)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH + Co. KG, Maulburg (DE)

(21) Appl. No.: 12/226,603

(22) PCT Filed: Apr. 13, 2007
(86) PCT No.: PCT/EP2007/053600

§ 371 Date: Feb. 9, 2009

(30) Foreign Application Priority Data
Apr. 27, 2006 (DE) 10 2006 020 267.8

(51) Int. Cl. G06F 11/28

(52) U.S. Cl. 714/46; 714/E11.178

(57) ABSTRACT

A method for displaying the quality of a digital communications link for field devices of automation technology on a field device serving as a monitoring unit. According to the method telegrams are transmitted via the communications link and are tapped in the monitoring unit and tested according to at least two criteria. The result of the testing is displayed as a bar chart on the monitoring unit, so that the user can observe quality of the communications link simply and easily.

The invention relates to a method for displaying quality of a digital communications link for field devices of automation technology, as defined in the preamble of claim 1.

Various methods and apparatuses are known for displaying quality of communications links of field devices. Thus, one technique involves indicating quality by means of a blinking indicator (LED-display) provided on the field device. Different colors are presented. A green blinking indicator shows the user, however, only, that the communications link is working. Such a signaling offers the user no opportunity, in the case of a malfunctioning communications link, for localizing the source of the malfunction.

Also known is signaling with two blinking indicators, one for the sending, and the other for the receiving, of data. Such signaling is, however, only suitable for a specialist. The normal user can, as a rule, figure little out from such signaling.

Furthermore, relatively complex bus monitors are known, which are provided as completely separate units and which must be operated by a specialist.

An object of the invention is, therefore, to provide a method for displaying quality of a digital communications link for field devices of automation technology, not having the above mentioned disadvantages, while, especially, offering an easily understandable presentation of the quality of the communications link, combined with being cost-favorable and simple to put into practice.

This object is achieved by the features set forth in claim 1.

An essential idea of the invention is to apply a field device serving as a monitoring unit to tap telegrams transmitted via the communications link and to subject the tapped telegrams to testing based on at least two criteria. Graphical presentation of the result of the testing is then accomplished on the basis of a bar chart shown on a display integrated into the monitoring unit. The height of an individual bar of the chart is a measure for the number of fulfilled criteria of the telegram associated with the bar. In general, the higher the bar, the better is the communications link.

Advantageous further developments of the invention are presented in the dependent claims.

In a further development of the invention, the criteria are tested sequentially, with the testing of a next criterion depending on the fulfillment of the preceding criterion. In case a criterion is not fulfilled, testing of subsequent criteria is no longer needed.

In an additional development, the bar chart is regularly updated. The individual bars are, in such case, shifted step-wise across the display. Bars corresponding to telegrams received a longer time ago are shifted out of the display window.

In the case of a field device operating as slave, updating is performed on a fixed clocking schedule, e.g. each second.

If the monitoring unit is a field device with master functionality, then the updating is performed according to the query/response telegram sequence. For each master-originated query there should follow, in such case and in each case, a slave-originated, response telegram.

The invention will now be explained in greater detail on the basis of an embodiment shown in the drawing, the figures of which show as follows:

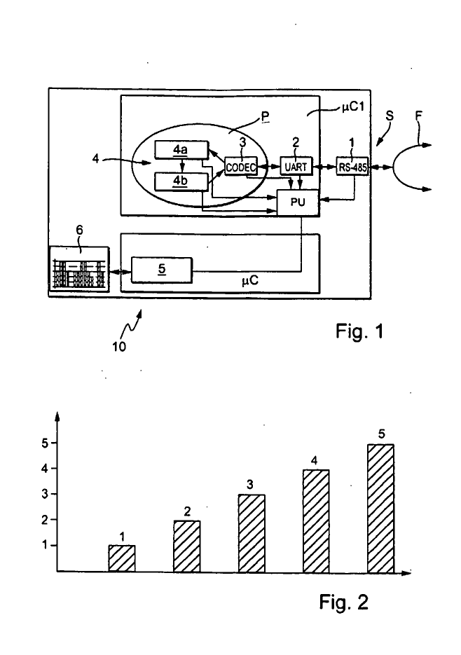

FIG. 1 block diagram of a field device of automation technology, serving as monitoring unit;

FIG. 2 schematic drawing of a bar chart with bars of different bar heights;

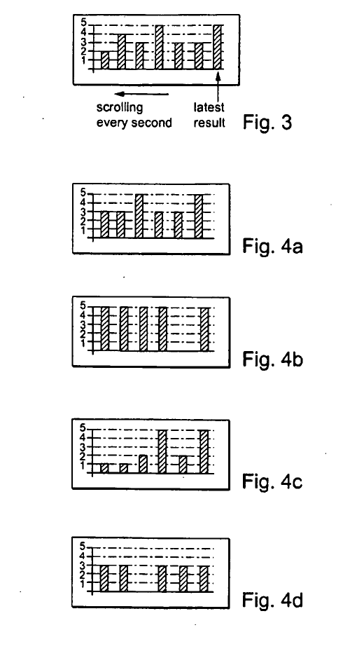

FIG. 3 picture of a bar chart on a field device at a point in time;

FIG. 4a bar chart of a communications link with a plurality of connected field devices;

FIG. 4b bar chart for a communications link with only one connected field device;

FIG. 4c bar chart for a communications link having poor quality;

FIG. 4d bar chart for a communications link having good quality, wherein the monitoring unit is not participating in the communication; and

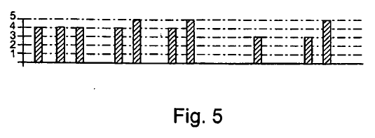

FIG. 5 a diagram for a monitoring unit having master functionality.

FIG. 1 shows a field device 10 of automation technology. Field device 10 serves as a monitoring unit and has an interface IF to a fieldbus F. Data are exchanged with the fieldbus F via an RS-485 connection unit 1, which is connected with a UART input 2 of a communications-controller μC1. The microcontroller μC1 is responsible only for communication of the field device with the fieldbus F. Besides the UART-connection, microcontroller μC1 also includes an encoder/decoder unit 3, which communicates with two processors, a query-processor 4a and a response-processor 4b.

The further functionality of the field device 10 is defined by the main-microcontroller μC, which can be connected e.g. with a sensor (not shown). Microcontroller μC includes, additionally, a generator unit 5 serving for producing a bar chart, which is displayable in a display unit 6. Also presentable in the display unit 6 can be further information, such as, e.g., measured values.

In the present example of an embodiment, components 3 and 4a, 4b are integrated as hardware on a protocol-chip P. Besides a hardware implementation, also an option is a software implementing of these functions.

For evaluation of test results, the communications-controller μC1 includes, additionally, a testing unit TU, which is connected with the individual components 1, 2, 3, 4a, 4b.

In the connection unit 1, the arriving, physical signals are converted into a bit-sequence. Here, the testing for correct bits takes place. The UART-input 2 changes the bit-sequence coming from the connection unit 1 into a byte-sequence. Here, the testing for correct bytes takes place. This byte-sequence is forwarded to the encoding/decoder unit 3, where the correct receipt of a telegram composed of a plurality of bytes is tested.

The query-processor 4a processes the incoming telegram and ascertains, whether the telegram was intended for the field device 10. The response-processor 4b reports, when a response telegram was sent.

All this test-information is collected in the testing unit TU, which forwards the result to the generator unit 5. There, the result of the testing is converted into a bar chart and transmitted to the display unit 6.

FIG. 2 shows a bar chart of different bar heights in greater detail. The bar 1 with the height 1 is output, when the bits of a telegram were correctly received. The bar 2 with the height 2 is output, when, additionally, the bytes of a telegram were correctly received. The bar 3 with the height 3 is output, when a telegram was correctly received, but it was addressed to another field device connected with the fieldbus. The bar 4 with the height 4 is output, when the telegram was correctly received and, also, was intended for the monitoring unit of interest, here, field device 10; however, still no response telegram was sent. The bar 5 with the height 5 is displayed, when, additionally, a response telegram was already sent.

If bars of the height of bars 1 and 2 are displayed on the display unit 6, this is an indication, that the quality of the communications link is not optimal.

FIG. 3 shows an example of a communications link having good quality, wherein additional field devices are exchanging telegrams via the communications link. Bar height 3 is for a telegram of another field device. When the telegrams of the monitoring unit reach the height 5, it is assured, that the monitoring unit has answered all queries.

FIG. 4 shows a “good” bar chart, in a case where a number of field devices are connected to the fieldbus.

FIG. 4b shows a bar chart, in a case where only the monitoring unit and a control system are attached to the communications link. The absence of a bar in the diagram can have various causes.

FIG. 4c shows a communications link having poor quality, since some bars only the height 2, or 1. This suggests EMC-problems due to in-coupling to the communications link, the fieldbus F.

FIG. 4d shows a communications link with good quality, wherein the monitoring unit 10, however, is not actively participating in the communications.

The bars in the examples of diagrams described to this point are, in each case, shifted by one bar spacing to the left after each time period. In this way, the user always has the quality of the last received telegrams in the eye. The current bar appears on the right of the screen. The oldest bar leaves the screen section on the left side.

Advantageously, updating of the bar chart is done on a fixed time schedule, e.g. after every second.

FIG. 5 shows a bar chart on the display of a monitoring unit, wherein the monitoring unit is providing a master functionality as regards the communications link. The master sends a query telegram to a slave-device and expects a response telegram from such. Following a query telegram (request-bar) are two repetitions. These two repetitions are labeled as retry-bars 1 and 2. Following the two repetitions, the master interrupts the communication, and, then, following a pause, sends a new query telegram. This new query telegram is correctly answered by the slave-device of concern with a response telegram. This response telegram reaches the bar height of 5.

The method of the invention will now be explained in greater detail.

In a first method step, in the monitoring unit 10, the communications link is tapped for data. In a second method step, the data in the monitoring unit 10 are tested on the basis of at least two criteria. The two criteria can be e.g. whether the bits and bytes in a telegram are correctly received. Other criteria are e.g. bytes correct and telegram correct. Following the testing, the result is displayed in a bar chart on the field device, wherein the height of the bars in the bar chart are a measure for the number of fulfilled criteria. The higher the telegram, the more criteria have been fulfilled.

With the method of the invention, a normal user can directly observe on the field device the quality of the communications link simply and safely. The modifications needed for the method on a conventional field device are not very extensive, so that the method is also relatively cost-favorable. The method of the invention is suited, quite specially, for tank applications, such as in the case e.g. of the product with designation NRF 590, as manufactured and sold by the assignee.

Subject matter of the invention is also a field device suitable for performing the method of the invention.

### LIST OF REFERENCE CHARACTERS

| | |
|---|---|
| main-microcontroller | μC |
| communications-controller | μC1 |
| connection unit | 1 |
| field device | 10 |
| UART-input | 2 |
| encoding/decoding unit | 3 |
| query-processor | 4a |
| response-processor | 4b |
| display unit | 6 |
| fieldbus | F |
| generator unit | 5 |
| protocol-chip | P |
| test unit | TU |
| interface | IF |

1-6. (canceled)

7. A method for the displaying quality of a digital communications link for field devices of automation technology on a field device serving as a monitoring unit, comprising the steps of:
tapping, in the monitoring unit, telegrams transmitted via the communications link;
testing the telegrams in the monitoring unit according to at least two criteria; and
graphically displaying results of the testing by way of a bar chart presented on a display of the monitoring unit, wherein the height of a bar of the chart is a measure of the number of criteria fulfilled by its telegram.

8. The method as claimed in claim 7, wherein:
the criteria are sequentially tested, and testing of an additional criterion depends on fulfillment of a preceding criterion.

9. The method as claimed in claim 7, wherein:
the bar chart is regularly updated and bars are shifted step-wise across the display.

10. The method as claimed in claim 9, wherein:
said updating occurs on a fixed clocking schedule.

11. The method as claimed in claim 9, wherein:
in the case of a field device functioning as master, updating occurs with each master-originated query-telegram and/or with each slave-originated response-telegram.

12. A field device for performing a method comprising the following steps:
tapping, in the monitoring unit, telegrams transmitted via the communications link;
testing the telegrams in the monitoring unit according to at least two criteria; and
graphically displaying results of the testing by way of a bar chart presented on a display of the monitoring unit, wherein the height of a bar of the chart is a measure of the number of criteria fulfilled by its telegram.
